(19) United States
(12) Patent Application Publication
(10) Pub. No.: US 2009/0015319 A1
(43) Pub. Date: Jan. 15, 2009

(54) VOLTAGE CONTROLLED OSCILLATION CIRCUIT

(75) Inventor: Tzu-Chien Tzeng, HsinChu (TW)

Correspondence Address: APEX JURIS, PLLC, 12360 LAKE CITY WAY NORTHEAST, SUITE 410, SEATTLE, WA, 98125, US

(73) Assignee: REALTEK SEMICONDUCTOR CORP., HsinChu (TW)

(21) Appl. No.: 12/167,952

(22) Filed: Jul. 3, 2008

(30) Foreign Application Priority Data
Jul. 13, 2007 (TW) 096125689

(51) Int. Cl. G05F 1/00

(52) U.S. Cl. 327/537

(57) ABSTRACT

The present invention provides a voltage controlled oscillator, which includes an amplifier circuit, an amplifier circuit tail current source, a latch circuit, a latch circuit tail current source, a load resistor, and a current modulation circuit. The amplifier circuit is provided with a first node, and an amplifier circuit tail current source having one end coupled to the first node and the other end coupled to the ground voltage (V_{GN}). The latch circuit is provided with a second node, and a latch circuit tail current source having one end coupled to the second node and the other end coupled to the ground voltage. The load resistor has one end electrically connected to the amplifier circuit and the latch circuit and the other end electrically connected to the power source voltage (V_{dd}). The current modulation circuit comprises a first PMOS switch, a second PMOS switch and a modulation circuit tail current source, wherein the first PMOS switch is coupled to the first node, the second PMOS switch is coupled to the second node, and the modulation circuit tail current source has one end coupled to the first PMOS switch and the second PMOS switch, and the other end coupled to the power source voltage.

### CROSS-REFERENCES TO RELATED APPLICATIONS

This non-provisional application claims priority under 35 U.S.C. §119(a) on Patent Application No(s). 96125689 filed in Taiwan, R.O.C. on Jul. 13, 2007, the entire contents of which are hereby incorporated by reference.

### FIELD OF INVENTION

The present invention is related to a voltage controlled oscillator, and particularly to a voltage controlled oscillator applied in a phase-locked loop.

### BACKGROUND

A conventional current mode logic (CML) latch-type voltage controlled oscillator (VCO) is constructed such that its output frequency curve may be maintained at first-order within a certain modulation range, and thus provides an advantage of high linearity, and relatively small phase noise in the oscillator if applied in a phase locked loop (PLL).

The conventional current mode logic latch-type voltage controlled oscillator (CML-latch type VCO) is implemented in a manner shown in FIG. 1A. The voltage controlled oscillator A1 comprises: an amplifier circuit A10, a cross-coupled latch circuit A20, a load resistor A30, and a current modulation circuit A40. The voltage output (Vₒᵤₜ) of the voltage controlled oscillator A1 is connected to the load capacitor (C_{load}). Therefore, the equivalent circuit to the above-mentioned voltage controlled oscillator A1 (VCO cell) can be treated as a RC loop formed by the outputted load capacitor and the resistance (−1/gm) parallel connection formed with the load resistor A30 and the cross-coupled latch circuit A20. The amplifier circuit A10 is used as a voltage controlled current source to provide the current to RC loop, so as to maintain the oscillation energy of the voltage controlled oscillator. Moreover, the current ratio flowing through the amplifier circuit A10 and the cross-coupled latch circuit A20 can be controlled by adjusting the first control voltage V_{C1} and the second control voltage V_{C2} in the current modulation circuit A40.

The working voltage and the biasing point of the current mode logic latch-type voltage controlled oscillator must guarantee all MOS transistors operating within the saturation region. As explained in FIG. 1A, using as an example one of the loops between the power source voltage (V_{dd}) to the ground voltage (V_{GN}), it cascades with the load resistor A30, one MOS transistor in the amplifier circuit A10, one MOS transistor in the current modulation circuit A40, and the current source in the current modulation circuit A40 (in application, the current source is usually the current mirrored by the MOS current mirror, so the current source can be used as MOS transistor). Therefore, it totally cascades with three MOS transistors and a load resistor A30. Thus, generally speaking, in order to make the voltage controlled oscillator operate correctly, the required working voltage is at least Vₜ+3V_{dsat}+V_{swing}; where, Vₜ is the threshold voltage of the MOS transistor, V_{dsat} is the saturation voltage of the MOS transistor, and V_{swing} is the drift voltage at both ends of the load resistor A30. In view of signal processing, the output amplitude of V_{swing} is usually required to be larger, so that the circuit can have better anti-noise and anti-jiggle capability. But in fact, in order to ensure the MOS transistor of the input amplifier at the next level circuit can also be maintained in the saturation region, the maximum of V_{swing} is Vₜ. Therefore, the working voltage required by the entire voltage controlled oscillator is at least 2Vₜ+3V_{dsat}, which is a very severe limitation for the trend of gradually reduced power source voltages. This limitation is especially obvious in the advanced process, in which the threshold voltage of the MOS transistor is increased relatively to the power source voltage, causing insufficient voltage headroom of the power source voltage, and limiting the application of the conventional current mode logic latch-type voltage controlled oscillator.

Please refer to FIG. 1B. It is seen that this figure shows the second example of the conventional current mode logic latch-type voltage controlled oscillator. In order to solve the above-mentioned voltage headroom problem, a method as shown in FIG. 1B is employed, wherein the current mirror A50 is used to change the current which need to be modulated to the power source end, and the PMOS transistor A60 is employed instead to control the voltage modulation amount. This method can reduce the operational voltage limitation of the voltage controlled oscillator in the first example from the original 2Vₜ+3V_{dsat} to 2Vₜ+2V_{dsat}, which reduces the voltage drop (i.e. one V_{dsat}) caused by cascading one MOS transistor.

However, a new problem will be generated by using the method in the second example, in which the mismatch of the current mirror A50 will cause an accumulation of errors, and further increase noise. The matching of the current mirror A50 must therefore be sufficient to prevent the error from being larger than the modulation amount. Because of the process conditions, it is not easy to manufacture the well matched transistors to compose the exactly matched current mirrors. Thus, the limitation of operational voltage can no doubt be reduced by the method employed in the second example, and the voltage headroom increased, but simultaneously the frequency error will increase due to the mismatch of current mirrors.

### SUMMARY

In response to this difficulty, the present invention provides a voltage controlled oscillator, which can be applied in the phase-locked loop operating in low voltage. The voltage controlled oscillator of the present invention not only possesses all the advantages of the conventional current mode latch-type voltage controlled oscillator, but also requires less power source voltage and increases the voltage headroom. Furthermore, the defects caused by the mismatch of the current mirrors are avoided by not using the current mirrors.

The present invention provides a voltage controlled oscillator, which includes an amplifier circuit, an amplifier circuit tail current source, a latch circuit, a latch circuit tail current source, a load resistor, and a current modulation circuit. The amplifier circuit is provided with a first node, and an amplifier circuit tail current source having one end coupled to the first node and the other end coupled to the ground voltage (V_{GN}). The latch circuit is provided with a second node, and a latch circuit tail current source having one end coupled to the second node and the other end coupled to the ground voltage. The load resistor has one end electrically connected to the amplifier circuit and the latch circuit and the other end electrically connected to the power source voltage (V_{dd}). The current modulation circuit comprises a first PMOS switch, a second PMOS switch and a modulation circuit tail current source, wherein the first PMOS switch is coupled to the first node, the second PMOS switch is coupled to the second node, and the modulation circuit tail current source has one end coupled to the first PMOS switch and the second PMOS switch, and the other end coupled to the power source voltage.

The present invention also provides a voltage controlled oscillator, which includes an amplifier circuit, an amplifier circuit tail current source, a latch circuit, a latch circuit tail current source, a load resistor, and a current modulation circuit. The amplifier circuit is provided with a first node, an amplifier circuit tail current source having one end coupled to the first node and the other end coupled to the power source voltage. The latch circuit is provided with a second node, and the latch circuit tail current source having one end coupled to the second node and the other end coupled to the power source voltage. The load resistor has one end electrically connected to the amplifier circuit and the latch circuit, and the other end electrically connected to the ground voltage. The current modulation circuit comprises a first NMOS switch, a second NMOS switch and a modulation circuit tail current source, wherein the first NMOS switch is coupled to the first node, the second NMOS switch is coupled to the second node, and the modulation circuit tail current source has one end coupled to the first NMOS switch and the second NMOS switch, and the other end coupled to the ground voltage.

The present invention also provides a voltage controlled oscillator, which includes an amplifier circuit, a latch circuit, an amplifier circuit tail current source, a latch circuit tail current source, and a current modulation circuit. The amplifier circuit has one end coupled to the output, and the other end provided with a first node. The latch circuit has one end coupled to the output, and the other end provided with a second node. The amplifier circuit tail current source is coupled to the first node for providing the first current amount flowing through the first node. The latch circuit tail current source is coupled to the second node for providing the second current amount flowing through the second node. The current modulation circuit is coupled to the first node and the second node for branching at least a portion of the current amount from the first current amount to determine the current amount flowing through the amplifier circuit, and for branching at least a portion of the current amount from the second current amount to determine the current amount flowing through the latch circuit based on at least one control voltage, wherein the oscillation frequency of the voltage controlled oscillation circuit is corresponding to the current amount flowing through the amplifier circuit and the current amount flowing through the latch circuit.

The preferred embodiments and the benefits regarding to the present invention will be further described in connection with the figures.

### BRIEF DESCRIPTION OF THE DRAWINGS

FIG. 1A is a first example of conventional current mode logic latch-type voltage controlled oscillator.

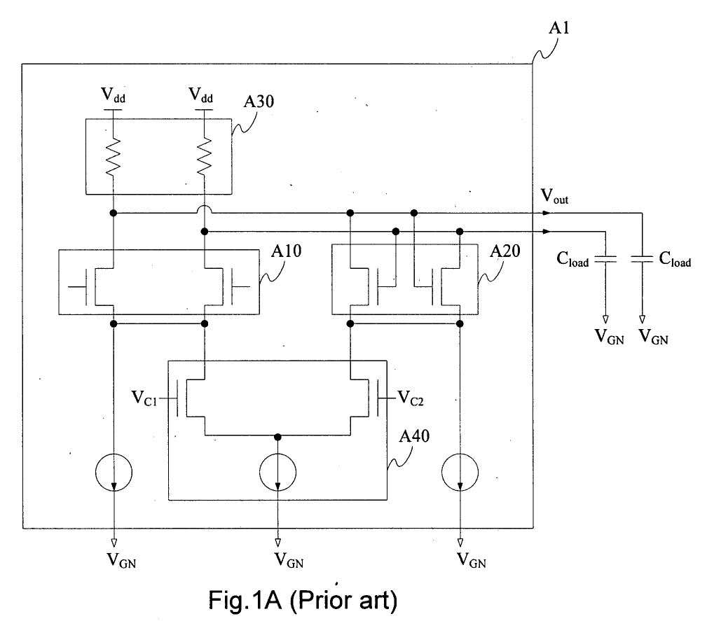

FIG. 1B is a second example of conventional current mode logic latch-type voltage controlled oscillator.

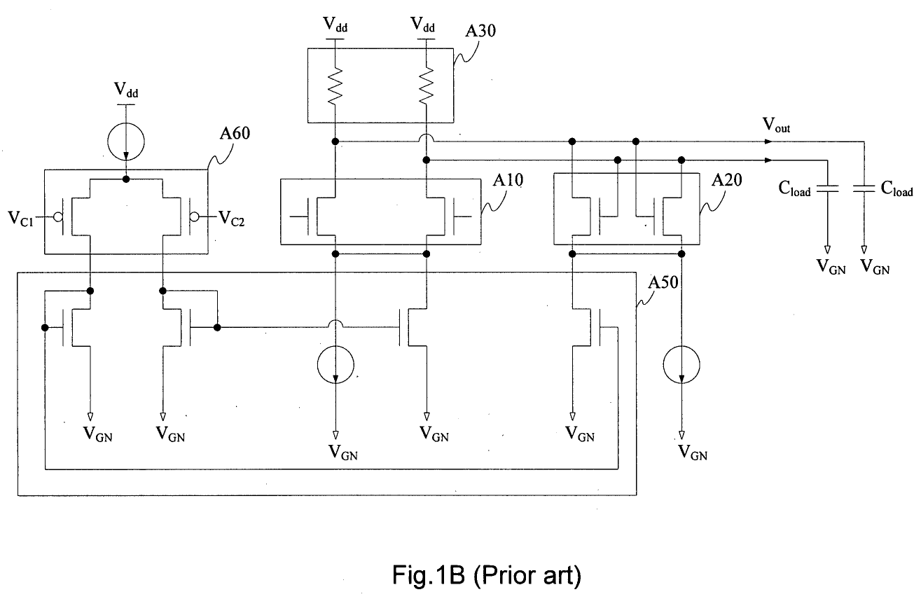

FIG. 2 is a first embodiment of voltage controlled oscillator of the present invention;

FIG. 3 is a second embodiment of voltage controlled oscillator of the present invention;

FIG. 4 is a third embodiment of voltage controlled oscillator of the present invention;

FIG. 5 is a fourth embodiment of voltage controlled oscillator of the present invention;

FIG. 6 is a fifth embodiment of voltage controlled oscillator of the present invention; and,

FIG. 7 is a sixth embodiment of voltage controlled oscillator of the present invention.

### DETAILED DESCRIPTION

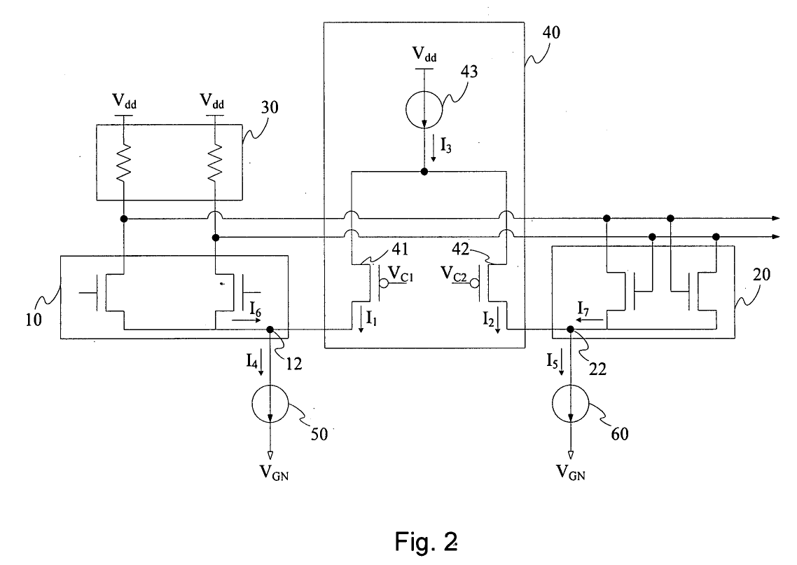

Please refer to FIG. 2, which shows a first embodiment of the voltage controlled oscillator of the present invention. The voltage controlled oscillator of the present embodiment comprises: an amplifier circuit 10, a latch circuit 20, a load resistor 30, a current modulation circuit 40, an amplifier circuit tail current source 50, and a latch circuit tail current source 60, in which the amplifier circuit 10, the latch circuit 20 and the load resistor 30 are connected with each other in a differential configuration.

The amplifier circuit 10 comprises a first node 12, while a latch circuit 20 includes a second node 22. In this embodiment, the amplifier circuit 10 is a differential amplifier composed of two NMOS transistors, while the latch circuit 20 is a cross-coupled pair composed of two NMOS transistors. The load resistor 30 is composed of a pair of resistors with one end electrically connected to the amplifier circuit 10 and the latch circuit 20, and the other end electrically connected to the power source voltage (V_{dd}). The current modulation circuit 40 comprises a first PMOS transistor 41, a second PMOS transistor 42, and a modulation circuit tail current source 43, wherein the first PMOS transistor 41 is connected to the first node 12 in the amplifier circuit 10, and the second PMOS transistor 42 is connected to the second node 22 in the latch circuit 20. The modulation circuit tail current source 43 has one end connected to the first PMOS transistor 41 and the second PMOS transistor 42, and the other end connected to the power source voltage (V_{dd}). The amplifier circuit tail current source 50 has one end connected to the first node 12 in the amplifier circuit 10 and the other end connected to the ground terminal (V_{GN}). The latch circuit tail current source 60 has one end connected to the second node 22 in the latch circuit 20 and the other end connected to the ground terminal (V_{GN}).

The first PMOS transistor 41 in the current modulation circuit 40 is connected to the first control voltage V_{C1}, and the current amount I₁ is controlled to flow from the modulation circuit tail current source 43 into the first node 12 by adjusting the first control voltage V_{C1}. Furthermore, in this embodiment the amplifier circuit tail current source 50 drains a fixed current amount 14 from the first node 12, and the current amount I₆ flowing through the amplifier circuit 10 equals I₄-I₁, which can be indirectly controlled by adjusting the first control voltage V_{C1}. Similarly, the second PMOS transistor 42 in the current modulation circuit 40 is connected to the second control voltage V_{C2}, and the current amount I₂ is controlled to flow from the modulation circuit tail current source 43 into the second node 22 by adjusting the second control voltage V_{C2}. Furthermore, in this embodiment the latch circuit tail current source 60 drains a fixed current amount I₅ from the second node 22, and the current amount I₇ flowing through the latch circuit 20 equals I₅-I₂, which can be indirectly controlled by adjusting the second control voltage V_{C2}.

In this embodiment, the current amount I₃ of the modulation circuit tail current source 43 is a fixed value, and a portion of the current I₃ (i.e. the current amount I₁) is flowing through the first PMOS transistor 41 to the first node 12, and the remaining portion of the current I₃ (i.e. the current amount I₂) is flowing through the second PMOS transistor 42 to the second node 22; that is, I₃=I₁+I₂. As shown in the figure, the first control voltage V_{C1} is connected to the gate of the first PMOS transistor 41, which adjusts the amount of the first control voltage V_{C1} to control the flowing current amount, and even make the first PMOS transistor 41 turn off (i.e. an open circuit). Similarly, the second control voltage V_{C2} is connected to the gate of the second PMOS transistor 42, which adjusts the amount of the second control voltage V_{C2} to control the flowing current amount, and even make the second PMOS transistor 42 turn off (i.e. an open circuit). Besides, the first PMOS transistor 41 and the second PMOS transistor 42 will be turned off simultaneously.

Using FIG. 2 as an example, if the first control voltage V_{C1} is decreased the current amount I₁ from the modulation circuit tail current source 43 flowing into the first node 12 will be increased, and the current amount I₆ flowing through the amplifier circuit 10 will be decreased; comparatively, if the second control voltage V_{C2} is increased, the current amount I₂ from the modulation circuit tail current source 43 flowing into the second node 22 will be decreased, and the current amount I₇ flowing through the latch circuit 20 will be increased. Conversely, if the first control voltage V_{C1} is increased, and the second control voltage V_{C2} is decreased, the current amount I₆ flowing through the amplifier circuit 10 will be increased, and the current amount I₇ flowing through the latch circuit 20 will be decreased. Therefore, by adjusting the first control voltage V_{C1} and the second control voltage V_{C2}, the ratio of the current amount I₆ flowing through the amplifier circuit 10 to the current amount I₇ flowing through the latch circuit 20 can be controlled, the different current amount corresponds to different biasing points, and the oscillation frequency of the voltage controlled oscillator will be changed accordingly.

It should be noted that in order to maintain the amplitude of output signal in the process of adjusting the oscillation frequency within a certain variation range as much as possible, the first control voltage V_{C1} and the second control voltage V_{C2} will usually be controlled by means of a differential signal, that is, the first control voltage V_{C1} and the second control voltage V_{C2} will be symmetrically varied with a common mode voltage level as the center. However, those proficient in electronic circuit design should understand that the present invention is not limited thereto.

As described above, in the voltage controlled oscillation circuit provided in this embodiment, the circuit mainly comprises an NMOS transistor (including amplifier circuit 10, latch circuit 20, amplifier circuit tail current source 50, and latch circuit tail current source 60 and so on), employs a current modulation circuit 40 based on PMOS transistors, and folds the current modulation mechanism upward to the power source end, that is, connects to the power source voltage (V_{dd}). In such a configuration the current modulation circuit 40 will be based on the amount of modulation of the first control voltage V_{C1} and the second control voltage V_{C2} to change the current amount of branching from the first node 12 and the second node 22, so as to change the current amount flowing the amplifier circuit 10 and the latch circuit 20 to adjust the oscillation frequency; that is, by subtracting a portion of current amount I₁ from the amplifier circuit tail current source 50, and subtracting a portion of current amount I₂ from the latch circuit tail current source 60 to determine the oscillation frequency. Thus the current modulation circuit 40 will not require the additional flipping of current mirrors as the conventional technique does, so defects caused by the mismatch of current mirrors are eliminated.

Furthermore, the voltage controlled oscillation circuit provided in this embodiment (using as an example a certain loop between the power source voltage (V_{dd}) to the ground voltage (V_{GN})), cascodes, in total, the load resistor 30, one MOS transistor in the amplifier circuit 10, and a current source connected to one end of the amplifier circuit 10 (actually the current source is usually the current mirrored by the MOS current mirror, so the current source can also be used as MOS transistor). Thus, in total two MOS transistors and one load resistor 30 are cascoded. Therefore, the overall consumed voltage required is Vₜ+2V_{dsat}+V_{swing}, in which the maximum of V_{swing} is Vₜ, as mentioned above. Thus, the overall consumed voltage by the voltage controlled oscillator is 2Vₜ+2V_{dsat}, which can save one V_{dsat} value compared to the consumed voltage 2Vₜ+3V_{dsat} in the conventional technique. Therefore, the voltage controlled oscillation circuit provided in the present invention can not only eliminate the defect caused by the mismatch of current mirrors, but also reduce the defect of excessively consumed voltage in the conventional technique, further increasing the voltage headroom of the overall circuit.

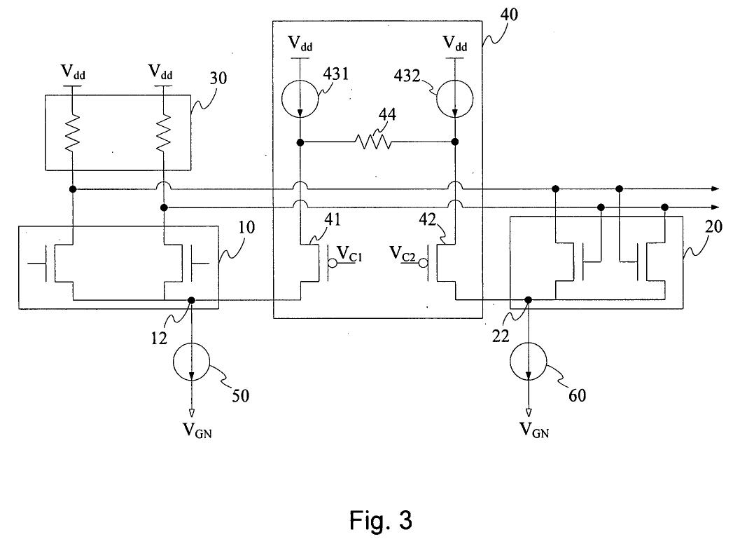

Please refer to FIG. 3, which is the second embodiment of the voltage controlled oscillator of the present invention. The difference between FIG. 3 and FIG. 2 is that the modulation circuit tail current source 43 in FIG. 3 comprises a first branch 431 and a second branch 432, in which the first branch 431 is connected to the first PMOS transistor 41, and the second branch is connected to the second PMOS transistor 42, and the current value of the first branch 431 and the second branch 432 is a half of the current value of the modulation circuit tail current source 43, that is, the original signal modulation circuit tail current source 43 is divided into two current branches, so that the total current value is matched with that of FIG. 2, which will not consume extra current.

FIG. 3 further comprises a branch resistor 44, and one end of the branch resistor 44 is connected to the intersection of the first branch 431 and the first PMOS transistor 41, and the other end is connected to the intersection of the second branch 432 and the second PMOS transistor 42. In this embodiment, there will be additional one branch resistor 44 connected between the first branch 431 and the second branch 432, which has the effect of source degeneration, so that the linear range of the control voltage of the current modulation circuit 40 will be wider, and the linearity of the current modulation circuit 40 will be increased.

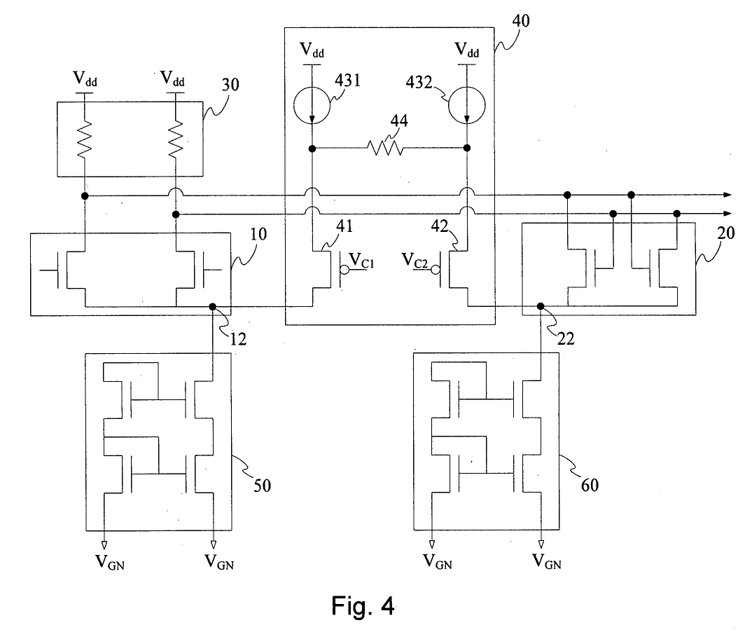

Refer to FIG. 4, which is a third embodiment of the voltage controlled oscillator of the present invention. FIG. 4 is based on the circuit structure of FIG. 3, and the derived circuit structure can be similarly applied in FIG. 2. In the third embodiment of FIG. 4 the amplifier circuit tail current source 50 connected to the first node 12 of the amplifier circuit 10 is implemented with cascade current mirrors. Similarly, the latch circuit tail current source 60 connected to the second node 22 of the latch circuit 20 can also be implemented with two sets of current mirrors cascaded to each other. The current source in cascade current mirror cascade configuration can reduce the interference caused by the noise generated by the voltage controlled oscillation circuit coupling to the other portion of the circuit through the current mirrors. On the other hand, the output impedance of the current mirror can be further increased, and the influence of channel length modulation can be reduced. In the two sets of current mirrors, the gate area of the components below (i.e. the one nearer the ground terminal) will usually be designed larger than the cascode one above (for example, the ratio of the two is 10:1), so that the achieved reduction in interference will be better. But the present invention is not limited thereto, and the number of cascade current mirrors is also not limited to two.

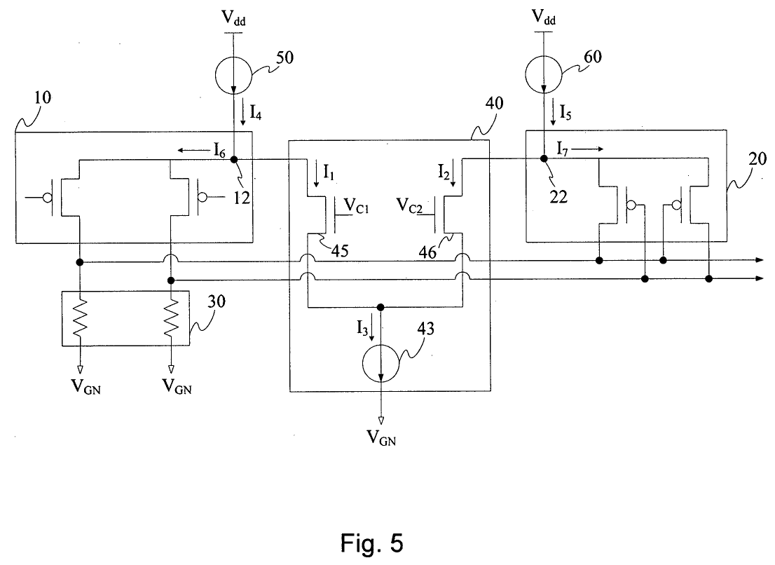

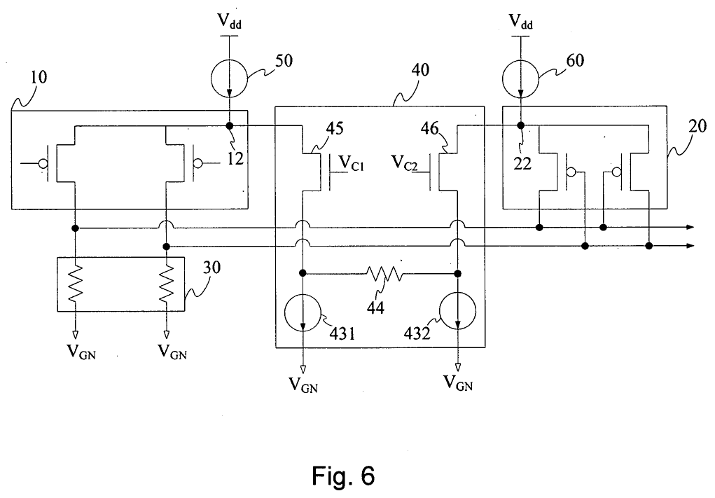

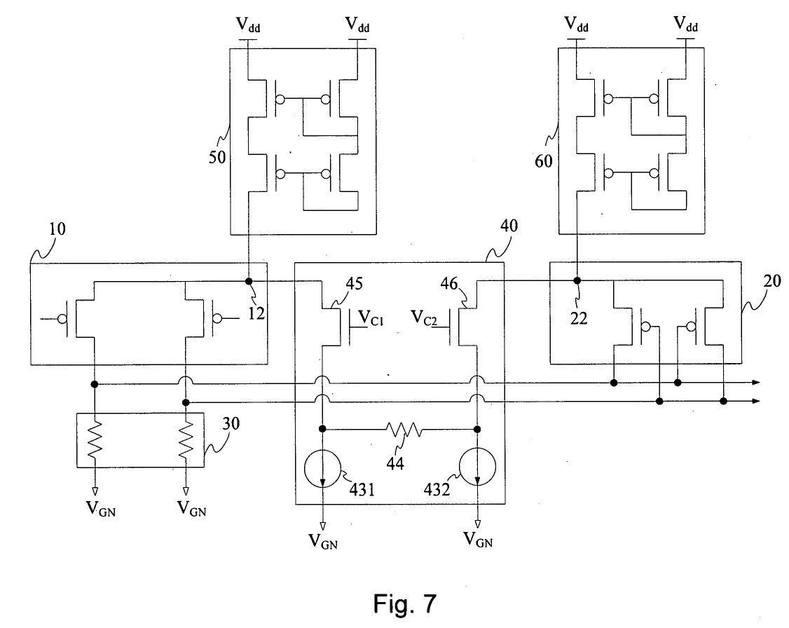

The three embodiments in FIG. 2, FIG. 3 and FIG. 4 can replace the MOS transistors in the amplifier circuit 10, the latch circuit 20, the current modulation circuit 40, the amplifier circuit tail current source 50, and the latch circuit tail current source 60 from PMOS to NMOS, and from NMOS to PMOS, and further swap the positions of the power source voltage (V_{dd}) and the ground voltage (V_{GN}). Therefore, it can be used as another type of complementary voltage controlled oscillation circuit. The embodiments as shown in FIG. 5, FIG. 6 and FIG. 7 are respectively the fourth, fifth and sixth embodiments of the voltage controlled oscillators of the present invention. The following will present an example using FIG. 5 for explanation, where FIG. 6 and FIG. 7 as mentioned above switch the PMOS, NMOS transistors in FIG. 3 and FIG. 4, and swap the power source voltage and the ground voltage.

Refer to FIG. 5, which is the fourth embodiment of the present invention. The embodiment is similar to the circuit structure of FIG. 2, and differs from the swap for the PMOS and NMOS, and swapping the positions of the power source voltage (V_{dd}) and the ground voltage (V_{GN}). Thus the other end of the load resistor 30 is changed to be electrically connected to the ground voltage (V_{GN}). The two switches contained in the current modulation circuit 40 are changed to the first NMOS transistor 45 and the second NMOS transistor 46. One end of the modulation circuit tail current source 43 is connected to the first NMOS transistor 45 and the second NMOS transistor 46, and the other end connected to the ground voltage (V_{GN}).

The first NMOS transistor 45 in the current modulation circuit 40 is connected to the first control voltage V_{C1}, and the first control voltage V_{C1} is adjusted to control the current amount I₁ from the amplifier circuit tail current source 50 flowing into the first node 12 to the modulation circuit tail current source 43. In this embodiment, the amplifier circuit tail current source 50 provides a fixed current amount I₄ from the first node 12, and the current amount I₆ flowing through the amplifier circuit 10 equals I₄-I₁, which can be indirectly controlled by adjusting the first control voltage V_{C1}. Similarly, the second NMOS transistor 46 in the current modulation circuit 40 is connected to the second control voltage, and the second control voltage V_{C2} is adjusted to control the current amount I₂ of the latch circuit tail current source 60 flowing into the second node 22 to the modulation circuit tail current source 43. In this embodiment, the latch circuit tail current source 60 provides a fixed current amount I₅ from the second node 22, and the current amount I₇ flowing through the latch circuit 20 equals I₅-I₂, which can be indirectly controlled by adjusting the second control voltage V_{C2}.

In this embodiment, the current amount I₃ of the modulation circuit tail current source 43 is fixed, and a portion of the current amount I₃ (i.e. the amount of the current I₁) is flowing in through the first NMOS transistor 45, and the remaining portion of the current amount I₃ (i.e. the amount of the current I₂) is flowing in through the second NMOS transistor 46; that is, I₃=I₁+I₂. As shown in the figure, the first control voltage V_{C1} is connected to the gate of the first NMOS transistor 45, and the amount of the first control voltage V_{C1} is adjusted to control the flowing current amount and even make the first NMOS transistor 45 turn off (i.e. an open circuit). Similarly, the second control voltage V_{C2} is connected to the gate of the second NMOS transistor 46, and the amount of the second control voltage V_{C2} is adjusted to control the flowing current amount, and even make the second NMOS transistor 46 turn off (i.e. an open circuit). Besides, the first NMOS transistor 45 and the second NMOS transistor 46 will be turned off simultaneously.

Using FIG. 5 as an example, if the first control voltage V_{C1} is decreased, the current amount I₁ of the amplifier circuit tail current source 50 flowing into the first node 12 will be decreased, and the current amount I₆ flowing through the amplifier circuit 10 will be increased; comparatively, if the second control voltage V_{C2} is correspondingly increased, the current amount I₂ of the latch circuit tail current source 60 flowing into the second node 22 will be increased, and the current amount I₇ flowing through the latch circuit 20 will be accordingly decreased. Conversely, if the first control voltage V_{C1} is increased, and the second control voltage V_{C2} is decreased, the current amount I₆ flowing through the amplifier circuit 10 will be decreased, and the current amount I₇ flowing through the latch circuit 20 will be increased. Therefore, the ratio of the current amount I₆ flowing through the amplifier circuit 10 and the current amount I₇ flowing through the latch circuit 20 can be controlled by adjusting the first control voltage V_{C1} and the second control voltage V_{C2}, and different current amounts are corresponding to different biasing points, and the oscillation frequency of the voltage controlled oscillator will be changed accordingly, so as to achieve the effect of using voltage to control the oscillation frequency.

Although the technical contents of the present invention have been disclosed with the preferred embodiments as above, they are not used to limit the present invention. Those proficient in the relevant fields can make a few changes and modifications without departing from the spirit of the present invention, which should be all covered within the scope of the present invention. Therefore, the protection scope of the present invention will be defined by the attached claims.

What is claimed is:

1. A voltage controlled oscillation circuit, which comprises:
an amplifier circuit, including a first node;
an amplifier circuit tail current source, having one end coupled to the first node, and the other end coupled to a ground voltage;
a latch circuit, including a second node;
a latch circuit tail current source, having one end coupled to the second node, and the other end coupled to the ground voltage;
a load resistor, having one end electrically connected to the amplifier circuit and the latch circuit, and the other end electrically connected to a power source voltage; and,
a current modulation circuit, including a first PMOS switch, a second PMOS switch and a modulation circuit tail current source, wherein the first PMOS switch is coupled to the first node, the second PMOS switch is coupled to the second node, and the modulation circuit tail current source has one end coupled to the first PMOS switch and the second PMOS switch, and the other end coupled to the power source voltage.

2. The voltage controlled oscillation circuit according to claim 1, wherein the amplifier circuit, the latch circuit and the load resistor are coupled in a differential configuration.

3. The voltage controlled oscillation circuit according to claim 1, wherein the first PMOS switch in the current modulation circuit is coupled to the first control voltage, and the current amount flowing from the modulation circuit tail current source into the amplifier circuit is controlled by adjusting the first control voltage.

4. The voltage controlled oscillation circuit according to claim 1, wherein the second PMOS switch in the current modulation circuit is coupled to a second control voltage, and the current amount flowing from the modulation circuit tail current source into the latch circuit is controlled by adjusting the second control voltage.

5. The voltage controlled oscillation circuit according to claim 1, wherein the modulation circuit tail current source comprises the first branch and the second branch, wherein the first branch is coupled to the first PMOS switch, and the second branch is coupled to the second PMOS switch.

6. The voltage controlled oscillation circuit according to claim 5, wherein the current value of the first branch and the second branch is half of the current value of the modulation circuit tail current source.

7. The voltage controlled oscillation circuit according to claim 5, further comprises a branch resistor, having one end coupled to the intersection of the first branch and the first PMOS switch, and the other end coupled to the intersection of the second branch and the second PMOS switch.

8. A voltage controlled oscillation circuit, which comprises:
an amplifier circuit, including a first node;
an amplifier circuit tail current source, having one end coupled to the first node, and the other end coupled to a power source voltage;
a latch circuit, including a second node;
a latch circuit tail current source, having one end coupled to the second node, and the other end coupled to the power source voltage;
a load resistor, having one end electrically connected to the amplifier circuit and the latch circuit, and the other end electrically connected to a ground voltage; and,
a current modulation circuit, including a first NMOS switch, a second NMOS switch and a modulation circuit tail current source, wherein the first NMOS switch is coupled to the first node, the second NMOS switch is coupled to the second node, and the modulation circuit tail current source having one end coupled to the first NMOS switch and the second NMOS switch, and the other end coupled to the ground voltage.

9. The voltage controlled oscillation circuit according to claim 8, wherein the amplifier circuit, the latch circuit and the load resistor are coupled in a differential configuration.

10. The voltage controlled oscillation circuit according to claim 8, wherein the first NMOS switch in the current modulation circuit is coupled to a first control voltage, and the first control voltage is adjusted to control the current amount flowing from the amplifier circuit tail current source into the amplifier circuit.

11. The voltage controlled oscillation circuit according to claim 8, wherein the second NMOS switch in the current modulation circuit is connected to a second control voltage, and the second control voltage is adjusted to control the current amount flowing from the latch circuit tail current source into the latch circuit.

12. The voltage controlled oscillation circuit according to claim 8, wherein the modulation circuit tail current source comprises a first branch and a second branch, wherein the first branch is coupled to the first PMOS switch, and the second branch is coupled to the second PMOS switch.

13. The voltage controlled oscillation circuit according to claim 12, wherein the current value of the first branch and the second branch is a half of the current value of the modulation circuit tail current source.

14. The voltage controlled oscillation circuit according to claim 12, further comprises a branch resistor, having one end coupled to the intersection of the first branch and the first PMOS switch, and the other end coupled to the intersection of the second branch and the second NMOS switch.

15. A voltage controlled oscillation circuit, which comprises:
an amplifier circuit, having one end coupled to an output, and the other end provided with a first node;
a latch circuit, having one end coupled to the output, and the other end provided with a second node;
an amplifier circuit tail current source, coupled to the first node for providing the first current amount flowing through the first node;
a latch circuit tail current source, coupled to the second node for providing the second current amount flowing through the second node; and,
a current modulation circuit, coupled to the first node and the second node for branching at least a portion of the current amount from the first current amount based on at least one control voltage to determine the current amount flowing through the amplifier circuit, and for branching at least a portion of the current amount from the second current amount to determine the current amount flowing through the latch circuit;
wherein the oscillation frequency of the voltage controlled oscillation circuit is corresponding to the current amount flowing through the amplifier circuit and the current amount flowing through the latch circuit.

16. The voltage controlled oscillation circuit according to claim 15, wherein the current modulation circuit comprises:
a first MOS switch, coupled to the first node for determining the current amount flowing through the amplifier circuit based on a control voltage; and,
a second MOS switch, coupled to the second node for determining the current amount flowing through the latch circuit based on the control voltage.

17. The voltage controlled oscillation circuit according to claim 15, wherein the amplifier circuit, the latch circuit and the load resistor are coupled in a differential configuration.

18. The voltage controlled oscillation circuit according to claim 15, wherein the amplifier circuit tail current source is formed by cascading at least one current mirror.

19. The voltage controlled oscillation circuit according to claim 15, wherein the latch circuit tail current source is formed by cascading at least one current mirror.
